(19) United States
(12) Patent Application Publication
(10) Pub. No.: US 2009/0192700 A1
(43) Pub. Date: Jul. 30, 2009

(54) Method and system for starting system prognosis and diagnosis

(75) Inventors: John Joseph Votoupal, Hudson, IL (US); David Frederick Schings, Edwards, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/010,849

(22) Filed: Jan. 30, 2008

(51) Int. Cl. F02D 45/00

(52) U.S. Cl. 701/113

(57) ABSTRACT

A starting system for an internal combustion engine includes an energy supply device, a starting device connected to the engine and the energy supply device, and a controller connected to the engine, the energy supply device, and the starting device. The controller is configured to cause the energy supply device to supply current to the starting device and monitor at least one characteristic of at least one of the energy supply device and the starting device after current is supplied to the starting device. The controller is also configured to diagnose at least the starting device based on the at least one monitored characteristic.

### TECHNICAL FIELD

The present disclosure relates generally to a starting system for an internal combustion engine, and more particularly, to a method and system for determining a prognosis and/or diagnosis of a starting system for an internal combustion engine.

### BACKGROUND

Internal combustion engines are generally started using a starter motor that engages gearing on an engine flywheel to cause an engine crankshaft to begin turning, thereby causing engine pistons to move within engine cylinders. As the engine turns over, fuel is introduced into the engine cylinders. In the case of spark ignited engines, spark plugs are energized to cause the fuel to ignite, thereby causing the engine to start running. In the case of compression ignited engines, the fuel ignites when the compression and heat in the engine cylinder reach sufficient levels, and then the engine starts running.

A controller or other circuitry may be provided for causing a gear on the starter motor to engage the gearing on the engine flywheel. The controller may cause electrical current to be applied to the starter motor to cause the starter motor to begin turning the engine. The starter motor may generally require a significant amount of power, which is generally supplied by a battery. In the event that the battery, or other device in the starting system, is performing less than optimally, then the starting system may have difficulty starting the engine or may be unable to start the engine.

It is desirable to be able to determine the performance level of the starting system. For example, when an engine is used in connection with a generator set for supplying standby power, it is desirable to know whether the starting system performance is sufficient to start the engine. Some starting systems generally measure battery voltage to determine whether there is sufficient power to start the engine. However, it is preferable to have a system that can determine whether the starting system performance is degrading even though the starting system may be performing within acceptable limits. This would allow preventative action to be taken and allow starting system maintenance to be performed prior to a complete starting system failure.

One system for monitoring a battery used to start an engine is described in U.S. Pat. No. 6,424,157 (the '157 patent) issued to Gollomp et al. The '157 patent describes measuring battery voltage and current drain during engine start, and computing battery state of charge (SOC). A rate of change of the battery SOC is computed to predict an expected remaining life of the battery. Performance of an alternator is also evaluated to determine whether the alternator is operating properly.

Although the system of the '157 patent may monitor a battery, the system of the '157 patent does not diagnose a starting device. The system of the '157 patent is unable to detect if the starting device is working properly, and therefore a no-start condition may occur without any advance warning to the operator due to a failure of the starting device. Furthermore, the system of the '157 patent does not store voltage, current, and temperature measurements of the alternator, and does not diagnose the alternator based on stored voltage, current, and temperature measurements. Therefore, the system may not provide a complete and accurate analysis of starting system performance. Degradation of starting system performance may not be able to be detected reliably.

The disclosed system is directed to overcoming one or more of the problems set forth above.

### SUMMARY

In one aspect, the present disclosure is directed to a starting system for an internal combustion engine. The starting system includes an energy supply device, a starting device connected to the engine and the energy supply device, and a controller connected to the engine, the energy supply device, and the starting device. The controller is configured to cause the energy supply device to supply current to the starting device and monitor at least one characteristic of at least one of the energy supply device and the starting device after current is supplied to the starting device. The controller is also configured to diagnose at least the starting device based on the at least one monitored characteristic.

In another aspect, the present disclosure is directed to a starting system for an internal combustion engine. The starting system includes an energy supply device, a charging device connected to the energy supply device and configured to charge the energy supply device, a starting device connected to the engine and the energy supply device, and a controller connected to the engine, the energy supply device, the charging device, and the starting device. The controller is configured to cause the energy supply device to supply current to the starting device and monitor at least one characteristic of at least one of the energy supply device, the starting device, and the charging device after current is supplied to the starting device. The controller is also configured to diagnose at least the energy supply device, the starting device, and the charging device based on the at least one monitored characteristic.

In a further aspect, the present disclosure is directed to a method of assessing performance of a starting system associated with an internal combustion engine. The starting system includes an energy supply device connected to an electronic controller, a charging device for charging the energy supply device, and a starting device connected to the engine. The method includes causing the energy supply device to supply current to the starting device, and monitoring at least one characteristic of at least one of the energy supply device, the starting device, and the charging device after current is supplied to the starting device. The method also includes determining a trend history of the at least one monitored characteristic and diagnosing at least one of the starting device and the charging device based on the at least one trend history.

### BRIEF DESCRIPTION OF THE DRAWINGS

FIG. 1 is a diagrammatic illustration of a starting system according to an embodiment; and

FIG. 2 is a flow chart of a control algorithm illustrating software control according to an embodiment.

### DETAILED DESCRIPTION

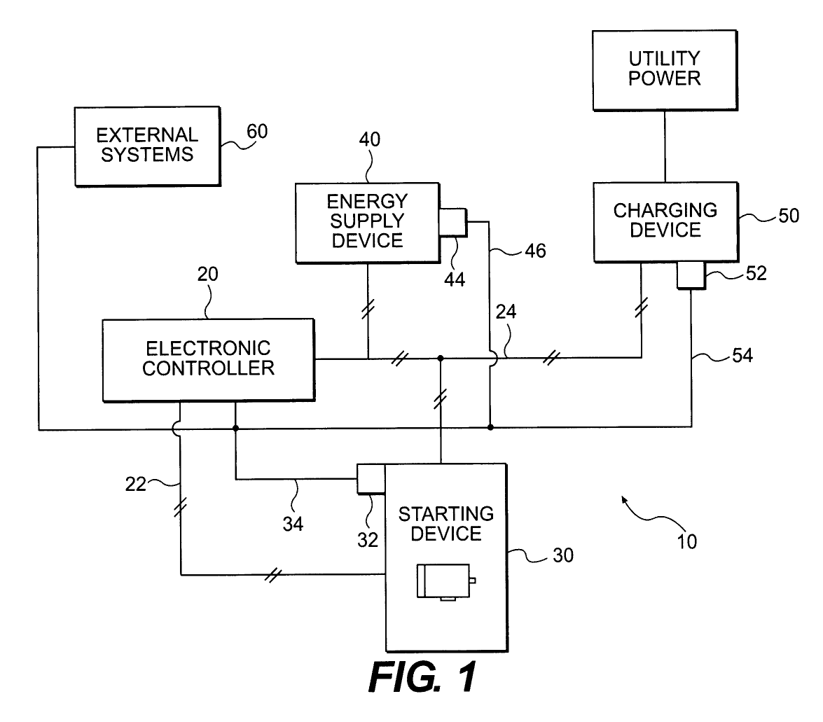

FIG. 1 illustrates a system level block diagram of a starting system 10 for a machine, according to an embodiment. As described below, the embodiment of the starting system 10 shown in FIG. 1 may be used in connection with any application of an internal combustion engine, e.g., an internal combustion engine on a generator set. It is understood, however, that the starting system 10 may be used with other internal combustion engines in machines other than generator sets. For example, the machine may be a fixed or mobile machine that performs some type of operation associated with an industry such as mining, construction, farming, transportation, power generation, tree harvesting, forestry, or any other industry known in the art. For example, the machine may be a truck, crane, earth moving machine, mining vehicle, material handling equipment, farming equipment, marine vessel, aircraft, an excavator, a dozer, a loader, a backhoe, a motor grader, a dump truck, a turbine, a power production system, an engine system operating in a plant or an off-shore environment, a feller, a harvesting machine, a skidder, a forwarder, a drag line system, or any type of machine that operates in an environment such as a construction site, mine site, power plant, tree harvesting site, etc.

The starting system 10 may include an electronic controller 20 that is connected via an electrical connector 22 to a starting device 30, such as a starter motor (e.g., an electric motor). The starting device 30 is associated with the engine. For example, in an embodiment, the starting device 30 may engage gearing on a flywheel of the engine to cause a crankshaft of the engine to begin turning, thereby causing engine pistons to move within engine cylinders. It is understood, however, that the starting device 30 may connect to the engine using other types of connections and is not limited to a configuration including a flywheel.

One or more sensors, e.g., sensors for sensing current, voltage, and/or temperature, may be provided for monitoring various characteristics of the starting system 10. According to an embodiment, the electronic controller 20 may include a memory (not shown) configured to store data, for example, data indicating the sensed current, voltage, and/or temperature measurements. For example, at least one starting device sensor 32 may be associated with the starting device 30 and may monitor at least one characteristic of the starting device 30, e.g., voltage into the starting device 30, voltage out of the starting device 30, current into the starting device 30, current out of the starting device 30, temperature at one or more points in the starting device 30, etc. Other characteristics associated with the starting device 30 may be monitored by the starting device sensor 32 as described below and as would be apparent to one skilled in the art. The starting device sensor 32 may provide a monitored characteristics signal indicating one or more of the monitored characteristics via a connector 34 to the electronic controller 20, and the monitored characteristics may be stored in the memory of the electronic controller 20.

The electronic controller 20 may also be connected via an electrical connector 24 to an energy supply device 40. In an embodiment, the energy supply device 40 may include one or more batteries that provide power to the electronic controller 20, the starting device 30, and, in some embodiments, other systems (not shown).

At least one energy supply device sensor 44 may be associated with the energy supply device 40 and may monitor at least one characteristic of the energy supply device 40, e.g., voltage into the energy supply device 40, voltage out of the energy supply device 40, current into the energy supply device 40, current out of the energy supply device 40, temperature at one or more points in the energy supply device 40, etc. Other characteristics associated with the energy supply device 40 may be monitored by the energy supply device sensor 44 as described below and as would be apparent to one skilled in the art.

The energy supply device sensor 44 may provide a monitored characteristics signal indicating one or more of the monitored characteristics via a connector 46 to the electronic controller 20 and/or a charging device 50, such as a battery charger or an alternator. For example, the charging device 50 may provide the monitored characteristics signal to the electronic controller 20 via a connector 54, and the monitored characteristics may be stored in the memory of the electronic controller 20. However, it is understood that the electronic controller 20 may receive the monitored characteristics signal directly from the energy supply device sensor 44.

At least one charging device sensor 52 may be associated with the charging device 50 and may monitor at least one characteristic of the charging device 50, e.g., voltage into the charging device 50, voltage out of the charging device 50, current into the charging device 50, current out of the charging device 50, temperature at one or more points in the charging device 50, etc. Other characteristics associated with the charging device 50 may be monitored by the charging device sensor 52 as described below and as would be apparent to one skilled in the art. The charging device sensor 52 may provide a monitored characteristics signal indicating one or more of the monitored characteristics via the connector 54 to the electronic controller 20, and the monitored characteristics may be stored in the memory of the electronic controller 20.

In an embodiment, the connectors 34, 46, 54 permit the electronic controller 20 to communicate with the starting device 30, the energy supply device 40, the charging device 50, and other external systems 60. The connectors 34, 46, 54 may provide a direct wired connection, a wireless connection, or other suitable communications line including, e.g., one or more wireless and/or wire-line communication lines.

During the operation of the starting system 10, the electronic controller 20 may issue a starting signal to the starting device 30 via the electrical connector 22, which may activate a solenoid and cause a starter motor gear to engage gearing on the flywheel of the internal combustion engine. The starting signal also causes the energy supply voltage to be applied across the starter motor windings, thereby causing the starting device 30 to turn. The starting device 30 thereby causes the flywheel to turn and begins turning over the engine.

In a generator set application, the charging device 50 may control the application of a charging current to the energy supply device 40 via the electrical connector 24 when the internal combustion engine is not running. The charging current applied by the charging device 50 to the energy supply device 40 may be a function of several factors including, e.g., the monitored characteristic of the energy supply device 40 indicated by the monitored characteristics signal from the energy supply device sensor 44 via connector 46. For example, the monitored characteristic may be one or more of a voltage, current, and temperature of the energy supply device 40.

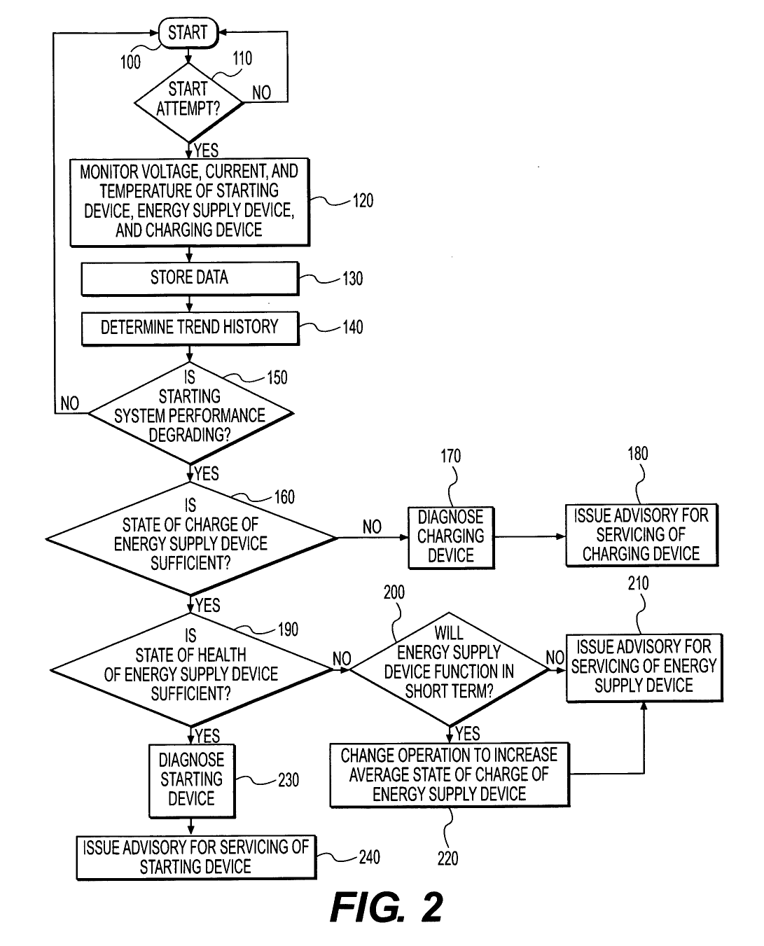

FIG. 2 shows a flow chart depicting an embodiment of an algorithm of the software control used in connection with the starting system 10 shown in FIG. 1. Program control begins at block 100.

In block 110, the electronic controller 20 determines whether the starting system 10 is attempting to start the engine. When the starting system 10 attempts to start the engine, the electronic controller 20 causes electrical current to be applied to the starting device 30 to cause the starting device 30 to begin turning the engine. In an embodiment, the electronic controller 20 may determine that an attempt is being made when the electronic controller 20 issues a start command over the electrical connector 22 to the starting device 30. Alternatively, the electronic controller 20 may determine that an attempt to start the engine is being made based on other signals or conditions, e.g., a sensed engine speed, a sensed current to the starting device 30 and/or from the energy supply device 40, a key switch, or other conditions. If the starting system 10 is not attempting to start the engine, then control for this algorithm loops back to block 100. Otherwise, program control passes to block 120.

At least one sensor (e.g., one or more of the starting device sensor 32, the energy supply device sensor 44, the charging device sensor 52, etc.) may monitor at least one characteristic of the starting system 10. In block 120, the sensors 32, 44, 52 transmit the monitored characteristics signal indicating the monitored characteristic to the electronic controller 20. As described above, the monitored characteristic may be monitored from one or more of the starting device 30, the energy supply device 40, the charging device 50, etc. Therefore, the monitored characteristic may include one or more voltage, current, and temperature measurements of one or more of the starting device 30, the energy supply device 40, and the charging device 50. The monitored characteristic may be monitored one or more times after initiation of the starting attempt. Program control then passes to block 130.

In block 130, the electronic controller 20 stores data from the signals transmitted from the sensors 32, 44, 52 in memory. Program control then passes to block 140. In block 140, the electronic controller 20 determines a trend history. For example, the trend history may indicate a rate of change and other trends associated with each monitored characteristic of the starting system 10, e.g., the monitored voltage, current, and/or temperature of the starting device 30, the energy supply device 40, and/or the charging device 50. The trend history may include data for the monitored characteristics stored during at least two starting attempts, e.g., the monitored characteristic stored in block 130 and a monitored characteristic relating to at least one prior starting attempt. Program control then passes to block 150.

In block 150, the electronic controller 20 determines whether performance of the starting system 10 is degrading. The electronic controller 20 may determine whether starting system performance is degrading based on the trend history determined in block 140. The electronic controller 20 may determine whether the voltage, current, and/or temperature measured by the sensors 32, 44, 52 are within a predetermined range of expected voltages, currents, and/or temperatures, or whether the rates of change of the measured voltage, current, and/or temperature are within a predetermined range of expected rates of change. The predetermined range of expected voltages, currents, and/or temperatures may be determined based on the trend history, e.g., an averaging or weighting of previous measurements.

In an embodiment, the electronic controller 20 may segregate the previously measured voltage and current measurements according to the temperature measurements associated with the respective voltage and current measurements. For example, the voltage and current measurements may be segregated into temperature blocks according to the associated temperature measurements. Then, the electronic controller 20 may determine that starting system performance is degrading if the voltage measurement is lower than a previously measured voltage (e.g., the voltage measurement from the immediately preceding starting attempt or other previous voltage measurements) associated with an approximately equal current measurement and in the same temperature block. The electronic controller 20 may also determine that starting system performance is degrading if the current measurement is higher than a previously measured current (e.g., the current measurement from the immediately preceding starting attempt or other previous current measurements) associated with an approximately equal voltage measurement and in the same temperature block. If the electronic controller 20 determines that the performance of the starting system 10 is not degrading (block 150; no), then program control returns to block 100, otherwise program control passes to block 160.

In block 160, the electronic controller 20 determines whether a state of charge (SOC) of the energy supply device 40 is sufficient, e.g., if the energy supply device 40 had been sufficiently charged between starting attempts. For example, the electronic controller 20 may determine whether the SOC is above a predetermined threshold. The SOC may be expressed as a SOC value that is equal to the ratio of the amount of energy presently stored in the battery to a nominal rated capacity of the energy supply device 40. Alternatively, the electronic controller 20 may determine a SOC value by calculating a length of time that the charging device 50 has been charging the energy supply device 40 between starting attempts. For example, the electronic controller 20 may determine whether the charging device 50 has been applying a charge to the energy supply device 40 for more than 24 hours. The electronic controller 20 may also store the determined SOC values of the energy supply device 40. The electronic controller 20 may then determine if the SOC value is above a predetermined threshold to determine whether the SOC of the energy supply device 40 is sufficient. If, in block 160, the electronic controller 20 determines that the energy supply device 40 has not been sufficiently charged (block 160; no), then program control passes to block 170, otherwise program control passes to block 190.

In block 170, the electronic controller 20 diagnoses the charging device 50. For example, the electronic controller 20 may determine whether a monitored characteristic of the charging device 50 is recognized as indicating that the charging device 50 is operating properly. The monitored characteristic may include an operating characteristic of a component (e.g., a belt) of the charging device 50, a measured characteristic described above (e.g., voltage, current, and/or temperature) of the charging device 50 or other component of the starting system 10, and/or a stored trend history of the measured characteristic of the charging device 50, etc. Therefore, the monitored characteristic may indicate, e.g., whether the charging device 50 is turning properly, whether a component of the charging device 50 (e.g., a belt) is broken, whether an output (e.g., a voltage output) of the charging device 50 is within an acceptable predetermined range, whether the measured characteristic or the stored trend history of the measured characteristic is recognized as being indicative of a malfunctioning charging device 50, etc. For example, if the charging device 50 is an alternator, the alternator may be diagnosed to determine if it is turning properly. If the alternator is not turning, the alternator may be diagnosed to determine if a belt of the alternator is broken. If the alternator is turning, the alternator may be diagnosed to determine if there is a voltage at the output of the alternator and if the voltage is within an acceptable predetermined range. The stored trend history of measured characteristics, such as the stored trend histories of voltage, current, and/or temperature of the alternator, may be analyzed to determine whether the stored trend history is recognized as a trend history indicative of a malfunctioning alternator. For example, a rate of change, a minimum value, and/or a maximum value of one or more of the measured characteristics may be analyzed to determine whether the alternator is malfunctioning. Program control then passes to block 180.

In block 180, the electronic controller 20 notifies the operator that the starting system performance is degraded and advises the operator to service the charging device 50. For example, the notification may appear on a display screen, and/or the electronic controller 20 may transmit the notification through a communication system to a remote location. The notification may include other information, such as an advisory to call a maintenance technician to service the charging device 50 and/or information regarding the diagnosis of the charging device 50 in block 170.

In block 190, after the electronic controller 20 determines that the SOC of the energy supply device 40 is sufficient (block 160), the electronic controller 20 may determine whether a state of health (SOH) of the energy supply device 40 is sufficient, e.g., if the SOH of the energy supply device 40 has not deteriorated substantially. During the lifetime of the energy supply device 40, its performance or “health” tends to deteriorate gradually due to physical and chemical changes occurring with usage and age of the energy supply device 40 so that eventually the energy supply device 40 is no longer usable. Therefore, the SOH may indicate a general condition of the energy supply device 40 and its ability to deliver a specified performance compared with a fresh or standard energy supply device. For example, the SOH may take into account monitored characteristics, such as a number of charge-discharge cycles during the lifetime of the energy supply device 40, a usage history of the energy supply device 40, impedence, conductance, or other operating characteristics of the energy supply device 40, etc. The SOH may be represented by one or more SOH values so that a larger SOH value indicates that the energy supply device 40 is closer to a fresh or standard energy supply device, and a lower SOH value indicates that the energy supply device 40 is closer to an energy supply device that is no longer usable. The electronic controller 20 may compare the SOH value to a predetermined threshold to determine whether the SOH of the energy supply device 40 is sufficient.

Other monitored characteristics used to determine the SOH value may include a measured characteristic described above (e.g., voltage, current, and/or temperature) of the energy supply device 40 or other component of the starting system 10, the stored trend history of the measured characteristic, and/or whether the measured characteristic and/or stored trend history is recognized as being indicative of a deteriorating SOH of the energy supply device 40, etc. (e.g., indicative of a malfunctioning energy supply device 40). For example, a rate of change, a minimum value, and/or a maximum value of one or more of the measured characteristics may be analyzed to determine whether the SOH of the energy supply device 40 is sufficient. If, in block 190, the electronic controller 20 determines that the SOH of the energy supply device 40 is not sufficient (block 190; no), then program control passes to block 200, otherwise program control passes to block 230.

In block 200, the electronic controller 20 may predict whether the energy supply device 40 will function in the short term. For example, the electronic controller 20 may predict an estimated remaining life of the energy supply device 40 based on a diagnosis of the energy supply device 40. The electronic controller 20 may predict the estimated remaining life of the energy supply device 40 based on, e.g., a monitored characteristic of the energy supply device 40. The monitored characteristic may include a measured characteristic described above (e.g., voltage, current, and/or temperature) of the energy supply device 40 or other component of the starting system 10, and/or the stored trend history of the measured characteristic of the energy supply device 40, an ambient temperature, etc. Then, the electronic controller 20 may determine whether the predicted estimated remaining life of the energy supply device 40 is greater than a predetermined time limit. If, in block 200, the electronic controller 20 determines that the predicted estimated remaining life of the energy supply device 40 is not greater than a predetermined time limit (block 200; no), then program control passes to block 210, otherwise program control passes to block 220.

In block 210, the electronic controller 20 notifies the operator that the starting system performance is degraded and advises the operator to service the energy supply device 40. For example, the notification may appear on a display screen or the electronic controller 20 may transmit the notification through a communication system to a remote location. The notification may include other information, such as an advisory to call a maintenance technician to service the energy supply device 40, information regarding the diagnosis of the energy supply device 40 in block 200, and/or information regarding the predicted estimated remaining life of the energy supply device 40 determined in block 200.

In block 220, after the electronic controller 20 determines that the energy supply device 40 will function in the short term (block 200), the electronic controller 20 changes an operation of the starting system 10 to increase an average SOC of the energy supply device 40. The electronic controller 20 may determine the average SOC based on a stored trend history of the SOC values of the energy supply device 40. Then, the electronic controller 20 may increase the SOC of the energy supply device 40 above the average SOC by increasing an idle speed of the engine or modifying an output of the charging device 50, e.g., increasing the output voltage of the charging device 50. Program control then passes to block 210.

In block 230, after the electronic controller 20 determines that the SOH of the energy supply device 40 is sufficient (block 190), the electronic controller 20 diagnoses the starting device 30. For example, the electronic controller 20 may determine whether a monitored characteristic of the starting device 30 is recognized as indicating that the starting device 30 is operating properly. The monitored characteristic may include an operating characteristic (e.g., torque) of a component of the starting device 30, a measured characteristic described above (e.g., voltage, current, and/or temperature) of the starting device 30 or other component of the starting system 10, and/or a stored trend history of the measured characteristic of the starting device 30, etc. Therefore, the monitored characteristic may indicate whether the starting device 30 is cranking the engine properly, whether a component of the starting device 30 is broken, whether an output (e.g., a torque output) of the starting device 30 is within an acceptable predetermined range, whether the measured characteristic or the stored trend history of the measured characteristic is recognized as being indicative of a malfunctioning starting device 30, etc. For example, a rate of change, a minimum value, and/or a maximum value of one or more of the measured characteristics may be analyzed to determine whether the starting device 30 is malfunctioning. Program control then passes to block 240.

In block 240, the electronic controller 20 notifies the operator that the starting system performance is degraded and advises the operator to service the starting device 30. For example, the notification may appear on a display screen, or the electronic controller 20 may transmit the notification through a communication system to a remote location. The notification may include other information, such as an advisory to call a maintenance technician to service the starting device 30 and/or information regarding the diagnosis of the starting device 30 in block 230.

The flowchart described above depicts an embodiment of the algorithm used in connection with the electronic controller 20. Those skilled in the art will recognize that similar algorithms and software control may be used without deviating from the scope of the disclosure. Alternatively, instead of the electronic controller 20, a separate device, e.g., a handheld device or other device external to the starting system 10 and capable of receiving data from the starting system 10 through a wired or wireless connection, may perform the steps described above.

### INDUSTRIAL APPLICABILITY

The disclosed starting system for an internal combustion engine may be applicable to any machine that includes an engine connected to a starting system. The disclosed starting system may predict when a component of the starting system will fail before the machine ends up in a no-start condition and may also delay failure of the starting system component. The operation of the starting system will now be explained.

The starting system 10 is particularly useful in connection with generator set applications used for stand-by power. In stand-by power applications, the engine in the generator set is generally off, but is started at predetermined intervals and when the generator set senses an interruption in the power supplied by the utility service. Since it is important that the generator set engine start when the utility power is interrupted, it is important that the user know when performance of the starting system 10 is degraded, so that repairs may be made prior to a failure of the starting system 10. For example, the electronic controller 20 may determine what corrective actions to take and/or what component of the starting system 10 is the root cause of the problem. In this way, the starting system 10 may ensure that the generator set starts after a power interruption.

The electronic controller 20 is integrated into the machine and is configured to perform the steps described above. Since the electronic controller 20 may be integrated into the machine, the electronic controller 20 is capable of being continuously active in monitoring the starting system 10 and determining a prognosis and/or a diagnosis of one or more components of the starting system 10.

The electronic controller 20 may determine whether starting system performance is degrading, e.g., based on one or more trend histories determined from the measured current, voltage, and/or temperature (block 150). When determining whether starting system performance is degrading, the electronic controller 20 may segregate previously measured voltage and current measurements into temperature blocks according to temperature measurements associated with the respective voltage and current measurements. As a result, the electronic controller 20 may evaluate starting system performance based on the measured temperature. The starting system performance may be evaluated based on previous starting system performances within the same temperature group. Since the components of the starting system 10 may perform differently according to temperature, a more accurate determination of starting system performance may be provided, and degradation of starting system performance may be determined more reliably.

The electronic controller 20 may determine whether the SOC of the energy supply device 40 is sufficient (block 160). If the SOC of the energy supply device 40 is not sufficient (block 160; no), then the electronic controller 20 may diagnose the charging device 50 (block 170) and issue an advisory for servicing of the charging device 50 (block 180). As a result, the charging device 50 may be diagnosed to determine the cause of the insufficient SOC of the energy supply device 40. The operator may be informed regarding the specific cause of the degradation in starting system performance without requiring the operator to analyze the stored data or individually inspect the condition of the components of the starting system 10.

If the electronic controller 20 determines that the SOC of the energy supply device 40 is sufficient (block 160; yes), the electronic controller 20 may determine whether the SOH of the energy supply device 40 is sufficient, e.g., whether the condition of the energy supply device 40 has deteriorated (block 190). This determination may be based on monitored characteristics, such as the voltage, current, and temperature measurements and associated trend histories. Therefore, a more accurate determination of the SOH of the energy supply device 40 may be provided, and deterioration of the energy supply device 40 may be determined more reliably.

If the SOH of the energy supply device 40 is not sufficient (block 190; no), then the electronic controller 20 may predict when the energy supply device 40 will fail and may determine if the energy supply device 40 will function in the short term (block 200). The energy supply device 40 may also be diagnosed to determine the cause of the insufficient SOH of the energy supply device 40. This prediction and determination may be based on monitored characteristics, such as the voltage, current, and temperature measurements and associated trend histories. Therefore, a more accurate determination of the estimated remaining life of the energy supply device 40 may be provided.

If the electronic controller 20 determines that the energy supply device 40 is capable of failing in the short term (block 200; no), then the electronic controller 20 may issue an advisory for servicing of the energy supply device (block 210). The operator may be informed regarding the specific cause of the degradation in starting system performance without requiring the operator to analyze the stored data or individually inspect the condition of the components of the starting system 10.

If the electronic controller 20 determines that the energy supply device 40 is capable of functioning in the short term (block 200; yes), then the electronic controller 20 may alter the operation of the starting system 10 to increase the SOC of the energy supply device 40 (block 220) and issue an advisory for servicing of the energy supply device 40 (block 210). Since the electronic controller 20 may alter the operation of the starting system 10 to increase the SOC of the energy supply device 40, the electronic controller 20 may be able to delay the occurrence of a no-start condition or starting system failure until the operator is notified of the need to service the energy supply device 40. Then, the operator may be informed regarding the specific cause of the degradation in starting system performance without requiring the operator to analyze the stored data or individually inspect the condition of the components of the starting system 10.

If the electronic controller 20 determines that the SOH of the energy supply device 40 is sufficient (block 190; yes), then the electronic controller 20 may diagnose the starting device 30 (block 230) and issue an advisory for servicing the starting device 30 (block 240). As a result, the starting device 30 may be diagnosed to determine the specific cause of the degradation in starting system performance. The operator may be informed regarding the cause without requiring the operator to analyze the stored data or individually inspect the condition of the components of the starting system 10.

Using the steps described above, the electronic controller 20 is capable of selecting which one of the energy supply device, the starting device, and the charging device to diagnose based on at least one monitored characteristic, and informing the operator regarding the diagnosed device. As a result, the electronic controller 20 is capable of providing a prognosis and/or diagnosis of various components of the starting system 10.

It will be apparent to those skilled in the art that various modifications and variations can be made to the disclosed starting system. Other embodiments will be apparent to those skilled in the art from consideration of the specification and practice of the disclosed starting system. It is intended that the specification and examples be considered as exemplary only, with a true scope being indicated by the following claims and their equivalents.

What is claimed is:

1. A starting system for an internal combustion engine, comprising:
an energy supply device;
a starting device connected to the engine and the energy supply device; and
a controller connected to the engine, the energy supply device, and the starting device, the controller being configured to:
cause the energy supply device to supply current to the starting device;
monitor at least one characteristic of at least one of the energy supply device and the starting device after current is supplied to the starting device; and
diagnose at least the starting device based on the at least one monitored characteristic.

2. The starting system of claim 1, wherein the controller is configured to diagnose the starting device by determining whether the at least one monitored characteristic is recognized as being indicative of a malfunctioning starting device.

3. The starting system of claim 2, wherein the at least one monitored characteristic includes at least one of a voltage, current, and temperature.

4. The starting system of claim 1, wherein the controller is configured to determine that a state of charge of the energy supply device is above a state of charge predetermined threshold before diagnosing the starting device and that a state of health of the energy supply device is above a state of health predetermined threshold before diagnosing the starting device.

5. The starting system of claim 1, wherein the controller is configured to transmit an advisory message after diagnosing the starting device.

6. The starting system of claim 1, wherein the controller is further configured to diagnose the energy supply device based on the at least one monitored characteristic.

7. The starting system of claim 6, wherein the controller is further configured to diagnose the energy supply device by determining whether the at least one monitored characteristic is recognized as being indicative of a malfunctioning energy supply device.

8. The starting system of claim 6, wherein the controller is configured to determine that a state of charge of the energy supply device is above a predetermined state of charge threshold and that a state of health of the energy supply device is below a state of health threshold before diagnosing the energy supply device.

9. The starting system of claim 6, wherein the controller is configured to predict an estimated remaining life of the energy supply device.

10. The starting system of claim 6, wherein the controller is configured to change an operation of the starting system to increase a state of charge of the energy supply device.

11. The starting system of claim 1, further including a charging device connected to the energy supply device and configured to charge the energy supply device; the at least one monitored characteristic being of at least one of the energy supply device, the starting device, and the charging device after current is supplied to the starting device.

12. The starting system of claim 11, wherein the controller is further configured to diagnose the charging device based on the at least one monitored characteristic.

13. The starting system of claim 12, wherein the controller is further configured to diagnose the charging device by determining whether the at least one monitored characteristic is recognized as being indicative of a malfunctioning charging device.

14. The starting system of claim 11, wherein the controller is configured to determine that a state of charge of the energy supply device is below a state of charge predetermined threshold before diagnosing the charging device.

15. The starting system of claim 11, wherein the controller is further configured to diagnose the charging device and the energy supply device based on the at least one monitored characteristic.

16. A starting system for an internal combustion engine, comprising:
an energy supply device;
a charging device connected to the energy supply device and configured to charge the energy supply device;
a starting device connected to the engine and the energy supply device; and
a controller connected to the engine, the energy supply device, the charging device, and the starting device, the controller being configured to:
cause the energy supply device to supply current to the starting device;
monitor at least one characteristic of at least one of the energy supply device, the starting device, and the charging device after current is supplied to the starting device; and
diagnose at least the energy supply device, the starting device, and the charging device based on the at least one monitored characteristic.

17. The starting system of claim 16, wherein the controller is configured to select which one of the energy supply device, the starting device, and the charging device is a diagnosed device to diagnose based on the at least one monitored characteristic.

18. The starting system of claim 17, wherein the controller is configured to diagnose the diagnosed device by determining whether the at least one monitored characteristic is recognized as being indicative of a malfunctioning device.

19. The starting system of claim 16, wherein the at least one monitored characteristic includes voltage, current, and temperature.

20. A method of assessing performance of a starting system associated with an internal combustion engine, the starting system including an energy supply device connected to an electronic controller, a charging device for charging the energy supply device, and a starting device connected to the engine, the method comprising:
causing the energy supply device to supply current to the starting device;
monitoring at least one characteristic of at least one of the energy supply device, the starting device, and the charging device after current is supplied to the starting device; and
determining a trend history of the at least one monitored characteristic; and
diagnosing at least one of the starting device and the charging device based on the at least one trend history.

21. The method of claim 20, wherein the diagnosing of the at least one of the starting device and the charging device includes determining whether the trend history is recognized as being indicative of a respective one of a malfunctioning starting device and a malfunctioning charging device.

22. The method of claim 20, wherein the at least one characteristic is monitored during at least two starting attempts of the starting system, and the trend history includes the at least one characteristic monitored during the at least two starting attempts.

23. The method of claim 20, wherein the at least one monitored characteristic includes at least one of a voltage, current, and temperature.
